(19) United States
(12) Patent Application Publication
(10) Pub. No.: US 2022/0156655 A1
(43) Pub. Date: May 19, 2022

(54) SYSTEMS AND METHODS FOR AUTOMATED DOCUMENT REVIEW

(71) Applicant: Acuity Technologies LLC, Massapequa, NY (US)

(72) Inventor: Jaime Barrientos, Massapequa, NY (US)

(21) Appl. No.: 17/528,536

(22) Filed: Nov. 17, 2021

Related U.S. Application Data
(60) Provisional application No. 63/115,185, filed on Nov. 18, 2020.

(51) Int. Cl. G06Q 10/06; G06K 9/00; G06N 20/20

(52) U.S. Cl. CPC G06Q 10/0635; G06N 20/20; G06K 9/00469

(57) ABSTRACT

A system for automated document analysis includes a display, a processor, and a memory. The memory includes instructions stored thereon, which when executed by the processor, cause the system to: access a document, via a graphical user interface of a client portal, wherein the document is associated with a client account; receive data from a plurality of data sources; identify, by a first machine learning network, a risk factor of the document, based on the received data; perform, by a second machine learning network, an analysis including at least one of contract analytics, data analytics, risk factoring, or regression analysis based on the identified risk factor; determine an output based on the analysis; and displaying the output of the analysis on a display.

### CROSS-REFERENCE TO RELATED APPLICATIONS

The present application claims the benefit of and priority to U.S. Provisional Patent Application Ser. No. 63/115,185, filed on Nov. 18, 2020, the entire content of which being hereby incorporated by reference.

### TECHNICAL FIELD

The present disclosure relates to automated document review. More specifically, the present disclosure relates to automated review of documents to provide a recommendation regarding risk associated with the documents.

### SUMMARY

Aspects of the present disclosure are described in detail with reference to the drawings wherein like reference numerals identify similar or identical elements.

This disclosure relates to devices, systems, and methods for automated document analysis.

In accordance with aspects of the disclosure, a computer-implemented method for automated document analysis is presented. The method includes accessing a document, via a graphical user interface of a client portal, wherein the document is associated with a client account; receiving data from a plurality of data sources; identifying, by a first machine learning network, a risk factor of the document based on the received data; performing, by a second machine learning network, an analysis including at least one of contract analytics, data analytics, risk factoring, or regression analysis based on the identified risk factor; determining an output of the analysis; and displaying the output of the analysis on a display. The identifying is performed by generating, based on the received data, a data structure that is formatted to be processed through one or more layers of a machine learning model, the data structure having one or more fields structuring data; processing data that includes the data structure, through each of the one or more layers of the machine learning model that has been trained to predict a likelihood of the user selecting the piece of apparel; generating, by an output layer of the machine learning model, an output data structure, wherein the output data structure includes one or more fields structuring data indicating a likelihood of a particular risk factor; processing the output data structure to determine whether data organized by the one or more fields of the output data structure satisfies a predetermined threshold, wherein the output data structure includes one or more fields structuring data indicating a likelihood of the particular risk factor occurring; and generating the identified risk factor based on the output data of the machine learning model, wherein the recommendation includes the particular risk factor.

In an aspect of the present disclosure, the method may further include categorizing, by a third machine learning network, the document based on the analysis.

In another aspect of the present disclosure, the data may include a probability of loss, an application pre-fill, a current weather condition, an indication of political unrest, and/or a financial risk related event.

In yet another aspect of the present disclosure, the first machine learning network includes a classifier.

In a further aspect of the present disclosure, performing the analysis may further include text mining, spatial analysis, and/or catastrophic modeling.

In yet a further aspect of the present disclosure, the method may further include displaying a real-time dashboard.

In an aspect of the present disclosure, the dashboard may include a client profile, a risk profile, an account, invoicing, policies, budgeting, forecasting, financial risk, vulnerability assessments, catastrophic event modeling, regression analysis, and/or risk probability.

In another aspect of the present disclosure, identifying the risk factor may further include accessing an email and predicting, by a second classifier, a second risk factor based on the email.

In yet another aspect of the present disclosure, the method may further include accessing a second data from a sensor and identifying, by the first machine learning network, a second risk factor of the document based on the second data. Performing the analysis may be further based on the identified second risk factor.

In a further aspect of the present disclosure, the method may further include generating a secure link for submitting documents to be analyzed.

In accordance with aspects of the disclosure, a system for automated document analysis is presented. The system includes a display, a processor, and a memory. The memory includes instructions stored thereon, which when executed by the processor, cause the system to: access a document via a graphical user interface of a client portal, wherein the document is associated with a client account; receive data from a plurality of data sources; identify, by a first machine learning network, a risk factor of the document based on the received data; perform, by a second machine learning network, an analysis including at least one of contract analytics, data analytics, risk factoring, or regression analysis based on the identified risk factor; determine an output of the analysis; and display the output of the analysis on the display.

In yet a further aspect of the present disclosure, the instructions, when executed by the processor, may further cause the system to categorize, by a third machine learning network, the document based on the analysis.

In an aspect of the present disclosure, the data may include a probability of loss, an application pre-fill, a current weather condition, an indication of political unrest, and/or a financial risk related event.

In another aspect of the present disclosure, the first machine learning network may include a classifier.

In yet another aspect of the present disclosure, performing the analysis may further include text mining, spatial analysis, and/or catastrophic modeling.

In a further aspect of the present disclosure, the instructions, when executed by the processor, may further cause the system to display a real-time dashboard.

In yet a further aspect of the present disclosure, the dashboard may include a client profile, a risk profile, an account, invoicing, policies, budgeting, forecasting, financial risk, vulnerability assessments, catastrophic event modeling, regression analysis, and/or risk probability.

In an aspect of the present disclosure, when identifying the risk factor, the instructions, when executed by the processor, may further cause the system to: access an email and predict, by a second classifier, a second risk factor based on the email.

In another aspect of the present disclosure, the instructions, when executed by the processor, may further cause the system to: access a second data from a sensor; and identify, by the first machine learning network, a second risk factor of the document based on the second data. Performing the analysis may be further based on the identified second risk factor.

In accordance with aspects of the disclosure, a non-transitory storage medium that stores a program causing a processor to execute a method for automated document analysis is presented. The method includes: accessing a document, via a graphical user interface of a client portal, wherein the document is associated with a client account; receiving data from a plurality of data sources; identifying, by a first machine learning network, a risk factor of the document based on the received data; performing, by a second machine learning network, an analysis including at least one of contract analytics, data analytics, risk factoring, or regression analysis based on the identified risk factor; determining an output of the analysis; and displaying the output of the analysis on a display.

Further details and aspects of exemplary aspects of the present disclosure are described in more detail below with reference to the appended figures.

### BRIEF DESCRIPTION OF THE DRAWINGS

A better understanding of the features and advantages of the disclosed technology will be obtained by reference to the following detailed description that sets forth illustrative aspects, in which the principles of the technology are utilized, and the accompanying drawings of which:

FIG. 1 is a network diagram illustration, which shows an exemplary networked environment for a computer-implemented method of automated contract review in accordance with aspects of the present disclosure;

FIG. 2 is a block diagram of an exemplary server of FIG. 1 in accordance with aspects of the present disclosure;

FIG. 3 is a block diagram of supervised machine learning in accordance with the disclosure; and

FIG. 4 is a flow diagram for a method for automated document review in accordance with the disclosure.

Further details and aspects of exemplary aspects of the disclosure are described in more detail below with reference to the appended figures. Any of the above aspects and aspects of the disclosure may be combined without departing from the scope of the disclosure.

### DETAILED DESCRIPTION

Although the present disclosure will be described in terms of specific aspects, it will be readily apparent to those skilled in this art that various modifications, rearrangements, and substitutions may be made without departing from the spirit of the present disclosure. The scope of the present disclosure is defined by the claims appended hereto.

For purposes of promoting an understanding of the principles of the present disclosure, reference will now be made to exemplary aspects illustrated in the drawings, and specific language will be used to describe the same. It will nevertheless be understood that no limitation of the scope of the present disclosure is thereby intended. Any alterations and further modifications of the inventive features illustrated herein, and any additional applications of the principles of the present disclosure as illustrated herein, which would occur to one skilled in the relevant art and having possession of this disclosure, are to be considered within the scope of the present disclosure.

The ability of machine learning models to analyze large amounts of data—both structured and unstructured—can improve analytical capabilities in risk management and compliance, allowing, for example, risk managers in financial institutions to identify risks in an effective and timely manner, make more informed decisions, and for example make banking less risky.

The disclosed systems and methods analyze documents (e.g., legal documents) and extract important data points and clauses. The machine learning technology of the present disclosure allows analyzing thousands of commercial agreements in seconds, and this means a dramatic reduction of the time spent on back-end processes.

The disclosed system includes a risk management agency system that is a cloud based, collaborative software, that enables file sharing between clients. As a business communication platform, the system includes chat functions, mobile access, couple with artificial intelligence, application programming interface, machine learning, deep learning, data analytics, regression analysis, and proprietary processes, which enable the administrative functions associated with risk management, insurance documents to be streamlined, significantly reducing lead times associated with most functions and maximize business's operational value.

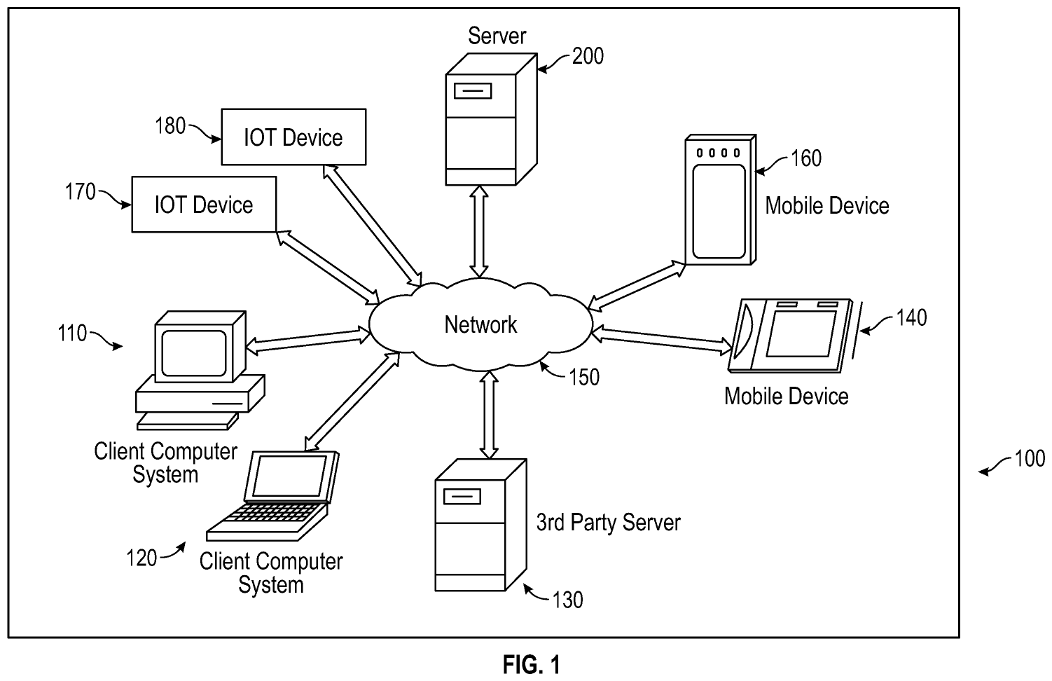

Referring to FIG. 1, there is shown an illustration of an exemplary networked environment 100 in accordance with aspects of the present disclosure. The system 100 includes one or more client computer systems 110, 120, a network 150, a server 200, and one or more mobile device 140, 160. The mobile device(s) 140, 160, or the client computer system 110, 120, communicate with the server 200 across the network 150 to manage data. In one example, the server 200 may store a user's personal profile and settings.

In the illustrated aspect, the networked environment 100 includes a third party server 130. In various aspects, the third-party server 130 can store and communicate user tasks, and the server 200 can import such user tasks from the third party server 130. In various aspects, data, services, or applications from third-party servers 130 may be used by the server 200 for scheduling operations. Such data from third-party servers 130 can include, for example, a user's available time, appointments, bank balances, tags, or the weather forecast. For example, the server 200 may allow social integration, such as allowing sharing of projects, events, tasks, documents, pictures, etc.

The network 150 may be wired or wireless and can utilize technologies such as Wi-Fi, Ethernet, Internet Protocol, UWB, 3G, 4G, and/or 5G, or other communication technologies. The network 150 may include, for example, a cellular network, residential broadband, satellite communications, private network, the Internet, local area network, wide area network, storage area network, campus area network, personal area network, or metropolitan area network.

The term “application” may include a computer program designed to perform particular functions, tasks, or activities for the benefit of a user. Application may refer to, for example, software running locally or remotely, as a standalone program or in a web browser, or other software that would be understood by one skilled in the art to be an application. An application may run on the server 200 or on a user device, including, for example, on a mobile device 140 or a client computer system 110.

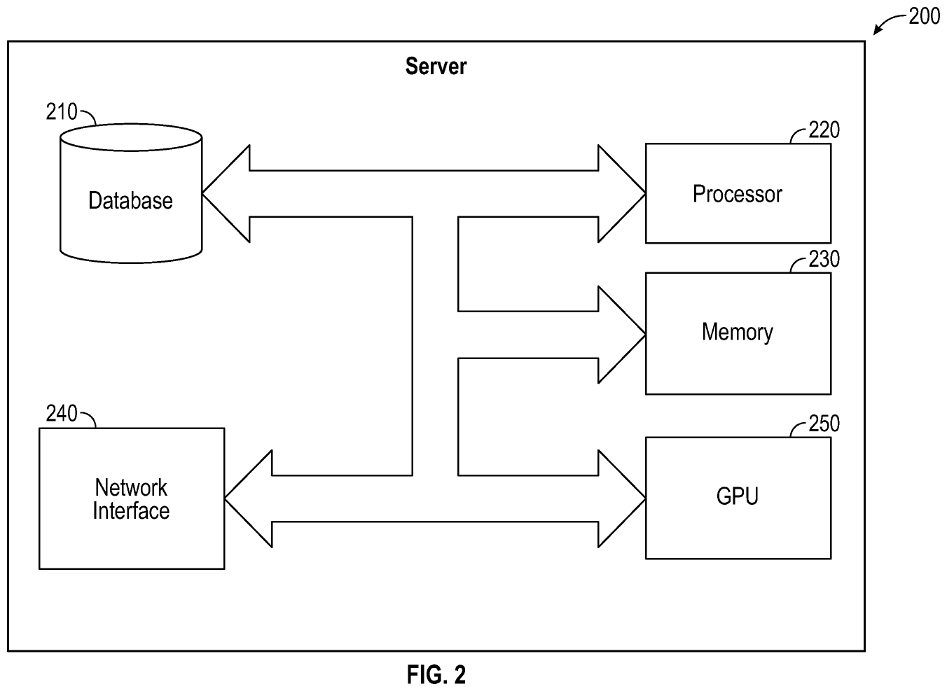

Referring now to FIG. 2, there is shown an illustration of exemplary components in the server 200 of FIG. 1, in accordance with aspects of the present disclosure. The server 200 includes, for example, a database 210, one or more processors 220, at least one memory 230, and a network interface 240.

The database 210 can be located in storage. The term “storage” may refer to any device or material from which information may be capable of being accessed or reproduced, or held in an electromagnetic or optical form for access by a computer processor. Storage may be, for example, volatile memory such as RAM, non-volatile memory, which permanently hold digital data until purposely erased, such as flash memory, magnetic devices such as hard disk drives, and optical media such as a CD, DVD, Blu-ray disc, or the like.

In one exemplary aspect of the present disclosure, a web interface can run on the server 200, where the interface includes a calendar application. In various aspects, data may be stored on the server 200, including, for example, user documents, preferences, risk factors, historical data, past weather, documents, and/or other data. The data can be stored in the server database 210, and sent via the system bus to the processor 220.

As will be described in more detail later herein, the processor 220 executes various processes based on instructions that can be stored in the server memory 230, and utilizing the data from the database 210. With reference also to FIG. 1, a request from a user device, such as a mobile device 140 or a client computer 110, can be communicated to the server 200, through the server's network interface 240. For example, a user can upload a document on a user computer 110. The server 200 can access the user's document, apply processing to the user's document, and provide the user with a risk assessment.

The risk assessment may appear through a web interface on the server 200, and the interface can include a dashboard that the user would see on his computer 110. In various aspects, push notifications can be sent to a browser in mobile devices 140, 160. Users can be notified of updates to their risk assessment by way of a push notification.

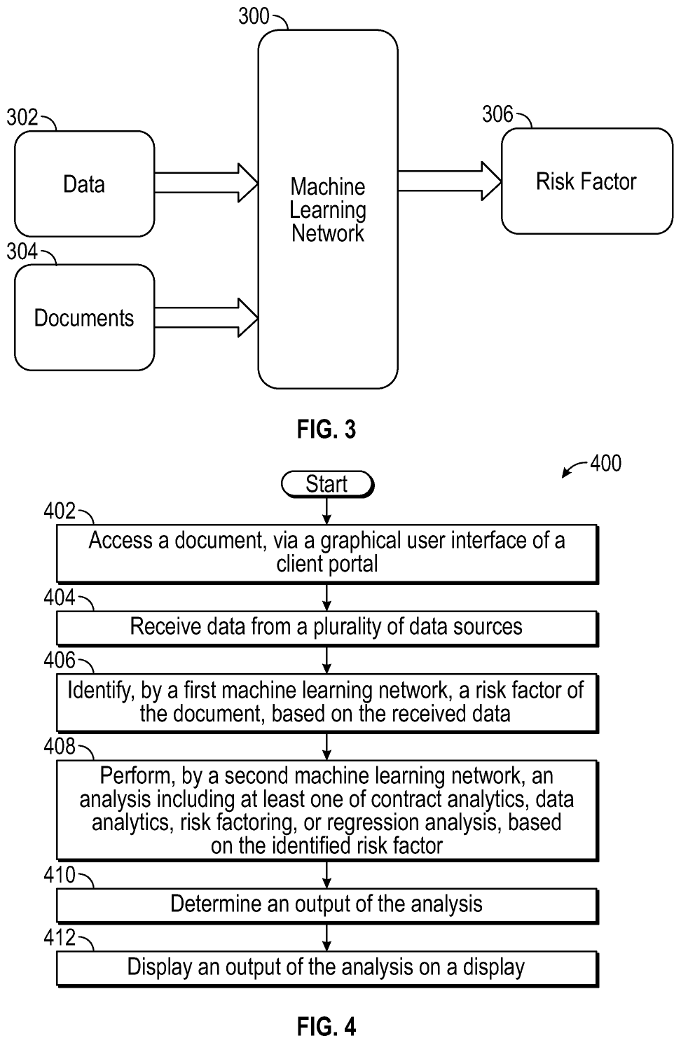

With reference to FIG. 3, a block diagram of supervised machine learning in accordance with the disclosure is shown. Machine learning algorithms are advantageous for use in identifying risk factors in documents, at least in that machine learning networks 300 may improve the functionality of document 304 review. Machine learning networks 300 utilize the initial input data (e.g., the previous risk-identification data, current risk-identification data, and/or experimental data) to determine statistical features and/or correlations that enable the identification of unknown risk factors by analyzing data therefrom. More specifically, processor 202 of controller 200 is configured, in response to receiving data from a user (e.g., a client), to input the document and/or other data into the machine learning algorithm(s) stored in storage device 208 in order to correctly identify risk factors. Although described with respect to an automated document review system, the aspects and features of controller 200 and the machine learning algorithms configured for use therewith are equally applicable for use with other suitable systems.

The terms “artificial intelligence,” “data models,” or “machine learning” may include neural networks, deep neural networks, recurrent neural networks (RNN), generative adversarial networks (GAN), Bayesian Regression, Naive Bayes, Monte Carlo Methods, nearest neighbors, least squares, means, and support vector regression, among other data science, artificial intelligence, and machine learning techniques.

The term “application” may include a computer program designed to perform particular functions, tasks, or activities for the benefit of a user. Application may refer to, for example, software running locally or remotely, as a standalone program or in a web browser, or other software that would be understood by one skilled in the art to be an application. An application may run on the controller 200 or on a user device, including, for example, on a mobile device, an IoT device, and/or a server system.

The automated document review system may identify a risk factor using at least one machine learning algorithm. For example, the system may use machine learning in order to increase the statistical probability that a risk factor will be correctly identified. In various aspects, by using a machine learning algorithm, various risk factors may be identified.

In various aspects, the neural network may include a temporal convolutional network or a feed-forward network. In various aspects, the neural network may be trained using one or more of measuring sensor data or identifying patterns in data. In various aspects, training the machine learning algorithm may be performed by a computing device outside of the server 200, and the resulting algorithm may be communicated to the server 200.

In one aspect, identifying the risk factor may be performed by generating, based on the received data, a data structure that is formatted to be processed through one or more layers of a machine learning model. The data structure may have one or more fields structuring data. Identifying the risk factor may further be performed by processing data that includes the data structure, through each of the one or more layers of the machine learning model that has been trained to predict a likelihood of the user selecting the piece of apparel; generating, by an output layer of the machine learning model, an output data structure, wherein the output data structure includes one or more fields structuring data indicating a likelihood of a particular risk factor; processing the output data structure to determine whether data organized by the one or more fields of the output data structure satisfies a predetermined threshold. The output data structure may include one or more fields structuring data indicating a likelihood of the particular risk factor occurring. Identifying the risk factor may further be performed by generating the identified risk factor based on the output data of the machine learning model, wherein the recommendation includes the particular risk factor.

In one aspect of the present disclosure, the algorithms in the present disclosure may be trained using supervised learning. Supervised learning is the machine learning task of learning a function that maps an input to an output based on example input-output pairs. It infers a function from labeled training data consisting of a set of training examples. In supervised learning, each example is a pair consisting of an input object (typically a vector) and the desired output value (also called the supervisory signal). A supervised learning algorithm analyzes the training data and produces an inferred function, which can be used for mapping new examples. In various aspects, the algorithm may correctly determine the class labels for unseen instances. This requires the learning algorithm to generalize from the training data to unseen situations in a “reasonable” way.

In various aspects, the neural network may include, for example, a three-layer temporal convolutional network with residual connections, where each layer may include three parallel convolutions, where the number of kernels and dilations increase from bottom to top, and where the number of convolutional filters increases from bottom to top. It is contemplated that a higher or lower number of layers may be used. It is contemplated that a higher or lower number of kernels and dilations may also be used.

With reference to FIG. 4, the flow diagrams include various blocks described in an ordered sequence. However, those skilled in the art will appreciate that one or more blocks of the flow diagram may be performed in a different order, repeated, and/or omitted without departing from the scope of the disclosure. The below description of the flow diagram refers to various actions or tasks performed by one or more servers 200, but those skilled in the art will appreciate that the server 200 is exemplary. In various aspects, the disclosed operations can be performed by another component, device, or system. In various aspects, the server 200 or other component/device performs the actions or tasks via one or more software applications executing on a processor. In various aspects, at least some of the operations can be implemented by firmware, programmable logic devices, and/or hardware circuitry. Other implementations are contemplated to be within the scope of the disclosure.

The following method 400 for automated document review brings contract analytics, data analytics, risk factoring, and regression analysis together. The disclosed method 400 uses external sources of data as well as AI, machine learning, text mining, spatial analysis, catastrophic modeling, structuring all data received to package the data and send it down the risk management assembly line, making the process more efficient and less chance of human error and/or delays. The method 400 may be used, for example, to manage clients, provide risk services, track significant risk industry-related events, as well as features such as billing, client profile, and/or risk profile.

Initially, at step 402, the server 200 accesses a document via a graphical user interface of a client portal. The document is associated with a client account. The document may include, for example, an insurance request and/or an agreement review.

Next, at step 404, the server 200 receives data from a plurality of data sources. The data includes a probability of loss, an application pre-fill, a current weather condition, an indication of political unrest, or a financial risk related event. The plurality of sources may include Chubb Property® API, national oceanic and atmospheric admin, state department, anonymous data, cookies, tracking code, social media monitoring, currency exchange info, and/or political happenings. For example, users (e.g., clients) may access their account for uploading data, documents, and/or reviewing the dashboard via a portal, a website login, an email link from the server 200, and/or a mobile application.

For example, a property manager could send the system pictures of the project via a mobile device. In another example, real-time accidents can be inputted into a mobile application for uploading to the server 200. In aspects, the server 200 may use a machine learning network to read an incident report and/or perform image recognition on pictures of an accident and/or other incident documentation.

In aspects, prospects, and/or other third-party stakeholders in relation to the client, which may be indirect to the risk, may submit documents such as policies, existing agreements, risk-related documents through a guest hyperlink. In aspects, the hyperlink may be a unique link generated based on a token, or for example, hashing the client's account information. In aspects, the method may use deep learning, machine learning, text mining, and/or document analytics to analyze the documents for streamlined use. For example, a 3rd Party (e.g., a dealership) can upload vehicle info, potential employee candidates can upload a resume, driver's license info, etc. In aspects, the method may generate a secure link for submitting documents to be analyzed.

Next, at step 406, the server 200 identifies, by a first machine learning network, a risk factor of the document, based on the received data. For example, the first machine learning network may be a classifier; however, other machine learning networks are contemplated. In aspects, the server 200 may look for phraseology from direct system inputs, emails received, and/or uploaded docs with regards to risk measures to aid in the risk factor identification.

In aspects, identifying the risk factor further includes accessing an email and predicting, by a second classifier or other machine learning network, a second risk factor based on the email.

In aspects, the server 200 may access data from a sensor (e.g., to monitor temperature, water level, etc.) as the second data. The sensor may include network connectivity (e.g., as Wi-Fi and/or Bluetooth) for reporting sensed data. In aspects, the server 200 may identify, by the first machine learning network, the second risk factor of the document, based on the second data. Performing the analysis may be further based on the identified second risk factor

In aspects, the data may be received from a mobile device application, which can be installed as part of front-line supervision, providing the ability to relay real-time data. In aspects, the server 200 and any client devices reactive real-time data and updates from each other.

The mobile application may include AI image recognition (e.g., machine vision). For example, a user may take a photo of a vehicle license plate, which would be recognized by the server 200 using, for instance, machine vision. In another example, machine vision may be used to determine spatial needs at property locations, e.g., sq. footage, and/or sprinklers.

Next, at step 408, the method performs, by a second machine learning network (e.g., a convolutional neural network and/or a state vector machine), an analysis including at least one of contract analytics, data analytics, risk factoring, or regression analysis based on the identified risk factor.

In aspects, performing the analysis may also include text mining, spatial analysis, and/or catastrophic modeling. In aspects, the server 200 may further categorize, by a third machine learning network, the document based on the analysis.

Next, at step 410, the server determines an output of the analysis. For example, the output may include determining a missing contractual element during a contract analysis.

Next, at step 412, the server 200 displays an output of the analysis on a display. In aspects, the method may display a real-time dashboard on the display.

The dashboard allows a user (e.g., a client) to track requests and view information that is not currently readily available today in the market but should be, and this system would allow that.

The dashboard may include, for example, a client profile, a risk profile, an account, invoicing, policies, budgeting, forecasting, financial risk, vulnerability assessments, catastrophic event modeling, regression analysis, and/or risk probability. In aspects, the server 200 may send emails reporting information relating to the risk factors. In aspects, the emails may include a tracking code embedded in emails for relaying information back to the server 200 of its progress, thus tracking the service.

In aspects, the server 200 may generate an automated response, such as prefilling a document (e.g., an application) based on client data.

In aspects, the server 200 may provide access to a client profile, a risk profile, accounts, invoicing, policies, budgeting, forecasting, financial risk, vulnerability assessments, catastrophic event modeling, regression analysis, and/or risk probabilities. The access may be controlled by the server 200.

In aspects, the dashboard may further include a key metrics view (e.g., showing higher risk factors and what data may be causing the risk factors value based on the analysis), provide the user access to real-time data, provide a means for the user to submit risk-related information (e.g., via portal upload, and/or email link), and/or display loss probabilities, forecasting, budgeting, and/or risk measure monitoring.

In aspects, the server 200 provides an input so that the user may designate access as needed to shorten data gathering time. In aspects, the dashboard allows the user to send requests related to risk management (e.g., the addition of building to a property policy, and/or reduction of workforce).

In aspects, the server 200 may provide a recommendation to the user based on the analysis. For example, if the server 200, based on its contract analytics of the document, determines that a contractual term is missing, the server 200 may display a recommendation to the user to have an attorney review the contract and provide an indication of the type of missing term.

Certain aspects of the present disclosure may include some, all, or none of the above advantages and/or one or more other advantages readily apparent to those skilled in the art from the drawings, descriptions, and claims included herein. Moreover, while specific advantages have been enumerated above, the various aspects of the present disclosure may include all, some, or none of the enumerated advantages and/or other advantages not specifically enumerated above.

The aspects disclosed herein are examples of the disclosure and may be embodied in various forms. For instance, although certain aspects herein are described as separate aspects, each of the aspects herein may be combined with one or more of the other aspects herein. Specific structural and functional details disclosed herein are not to be interpreted as limiting, but as a basis for the claims and as a representative basis for teaching one skilled in the art to variously employ the present disclosure in virtually any appropriately detailed structure. Like reference numerals may refer to similar or identical elements throughout the description of the figures.

The phrases “in an aspect,” “in aspects,” “in various aspects,” “in some aspects,” or “in other aspects” may each refer to one or more of the same or different aspects in accordance with the present disclosure. A phrase in the form “A or B” means “(A), (B), or (A and B).” A phrase in the form “at least one of A, B, or C” means “(A); (B); (C); (A and B); (A and C); (B and C); or (A, B, and C).”

Any of the herein described methods, programs, algorithms or codes may be converted to, or expressed in, a programming language or computer program. The terms “programming language” and “computer program,” as used herein, each include any language used to specify instructions to a computer, and include the following languages and their derivatives: Assembler, Basic, Batch files, BCPL, C, C+, C++, Delphi, Fortran, Java, JavaScript, machine code, operating system command languages, Pascal, Perl, PL1, scripting languages, Visual Basic, metalanguages which themselves specify programs, and all first, second, third, fourth, fifth, or further generation computer languages. Also included are database and other data schemas, and any other meta-languages. No distinction is made between languages which are interpreted, compiled, or use both compiled and interpreted approaches. No distinction is made between compiled and source versions of a program. Thus, reference to a program, where the programming language could exist in more than one state (such as source, compiled, object, or linked) is a reference to any and all such states. Reference to a program may encompass the actual instructions and/or the intent of those instructions.

It should be understood that the foregoing description is only illustrative of the present disclosure. Various alternatives and modifications can be devised by those skilled in the art without departing from the disclosure. Accordingly, the present disclosure is intended to embrace all such alternatives, modifications, and variances. The aspects described with reference to the attached drawing figures are presented only to demonstrate certain examples of the disclosure. Other elements, steps, methods, and techniques that are insubstantially different from those described above and/or in the appended claims are also intended to be within the scope of the disclosure.

What is claimed is:

1. A computer-implemented method for automated document analysis, the method comprising:
accessing a document, via a graphical user interface of a client portal, wherein the document is associated with a client account;
receiving data from a plurality of data sources;
identifying, by a first machine learning network, a risk factor of the document, based on the received data, wherein the identifying is performed by:
generating, based on the received data, a data structure that is formatted to be processed through one or more layers of a machine learning model, the data structure having one or more fields structuring data;
processing data that includes the data structure, through each of the one or more layers of the machine learning model that has been trained to predict a likelihood of the user selecting the piece of apparel;
generating, by an output layer of the machine learning model, an output data structure, wherein the output data structure includes one or more fields structuring data indicating a likelihood of a particular risk factor;
processing the output data structure to determine whether data organized by the one or more fields of the output data structure satisfies a predetermined threshold, wherein the output data structure includes one or more fields structuring data indicating a likelihood of the particular risk factor occurring; and
generating the identified risk factor based on the output data of the machine learning model, wherein the recommendation includes the particular risk factor;
performing, by a second machine learning network, an analysis including at least one of contract analytics, data analytics, risk factoring, or regression analysis based on the identified risk factor;
determine an output based on the analysis; and
displaying the output of the analysis on a display.

2. The computer-implemented method of claim 1, further comprising categorizing, by a third machine learning network, the document based on the analysis.

3. The computer-implemented method of claim 1, wherein the data includes at least one of: a probability of loss, an application pre-fill, a current weather condition, an indication of political unrest, or a financial risk related event.

4. The computer-implemented method of claim 1, wherein the first machine learning network includes a classifier.

5. The computer-implemented method of claim 1, wherein performing the analysis further includes at least one of text mining, spatial analysis, or catastrophic modeling.

6. The computer-implemented method of claim 1, further comprising displaying a real-time dashboard.

7. The computer-implemented method of claim 6, wherein the dashboard includes at least one of: a client profile, a risk profile, an account, invoicing, policies, budgeting, forecasting, financial risk, vulnerability assessments, catastrophic event modeling, regression analysis, or risk probability.

8. The computer-implemented method of claim 1, wherein identifying the risk factor further includes:
accessing an email; and
predicting, by a second classifier, a second risk factor based on the email.

9. The computer-implemented method of claim 1, further comprising:
accessing a second data from a sensor; and
identifying, by the first machine learning network, a second risk factor of the document based on the second data,
wherein performing the analysis is further based on the identified second risk factor.

10. The computer-implemented method of claim 1, further comprising generating a secure link for submitting documents to be analyzed.

11. A system for automated document analysis, comprising:
a display;
a processor; and
a memory, including instructions stored thereon, which when executed by the processor, cause the system to:
access a document, via a graphical user interface of a client portal, wherein the document is associated with a client account;
receive data from a plurality of data sources;
identify, by a first machine learning network, a risk factor of the document based on the received data;
perform, by a second machine learning network, an analysis including at least one of contract analytics, data analytics, risk factoring, or regression analysis based on the identified risk factor;
determine an output of the analysis; and
display an output of the analysis on the display.

12. The system of claim 11, wherein the instructions, when executed by the processor, further cause the system to categorize, by a third machine learning network, the document based on the analysis.

13. The system of claim 11, wherein the data includes at least one of: a probability of loss, an application pre-fill, a current weather condition, an indication of political unrest, or a financial risk related event.

14. The system of claim 11, wherein the first machine learning network includes a classifier.

15. The system of claim 11, wherein performing the analysis further includes at least one of text mining, spatial analysis, or catastrophic modeling.

16. The system of claim 11, wherein the instructions, when executed by the processor, further cause the system to display a real-time dashboard.

17. The system of claim 16, wherein the dashboard includes at least one of: a client profile, a risk profile, an account, invoicing, policies, budgeting, forecasting, financial risk, vulnerability assessments, catastrophic event modeling, regression analysis, or risk probability.

18. The system of claim 11, wherein when identifying the risk factor, the instructions, when executed by the processor, further cause the system to:
access an email; and
predict, by a second classifier, a second risk factor based on the email.

19. The system of claim 11, wherein the instructions, when executed by the processor, further cause the system to:
access a second data from a sensor; and
identify, by the first machine learning network, a second risk factor of the document, based on the second data,
wherein performing the analysis is further based on the identified second risk factor.

20. A non-transitory storage medium that stores a program causing a processor to execute a method for automated document analysis, the method comprising:
accessing a document, via a graphical user interface of a client portal, wherein the document is associated with a client account;
receiving data from a plurality of data sources;
identifying, by a first machine learning network, a risk factor of the document, based on the received data;
performing, by a second machine learning network, an analysis including at least one of contract analytics, data analytics, risk factoring, or regression analysis based on the identified risk factor;
determine an output based on the analysis; and
displaying the output of the analysis on a display.
